(19) United States
(12) Patent Application Publication
(10) Pub. No.: US 2011/0103817 A1
(43) Pub. Date: May 5, 2011

(54) IMAGE FORMING APPARATUS AND METHOD FOR CLEANING A LATENT IMAGE CARRIER

(75) Inventor: Tetsuya OKANO, Anjo (JP)

(73) Assignee: BROTHER KOGYO KABUSHIKI KAISHA, Aichi (JP)

(21) Appl. No.: 12/891,899

(22) Filed: Sep. 28, 2010

(30) Foreign Application Priority Data
Oct. 30, 2009 (JP) 2009-251286

(51) Int. Cl. G03G 15/00

(52) U.S. Cl. 399/71

(57) ABSTRACT

An image forming apparatus is provided. The image forming apparatus includes a latent image carrier, a conveyer system including nipping rollers to convey a sheet to vicinity of the latent image carrier, a switching system to switch operation modes between an image forming mode and a cleaning mode, and a cleaning controller to control a cleaning operation in the cleaning mode. The cleaning operation includes activating the conveyer system to convey a cleaner sheet at least until a front end reaches a position opposite from the latent image carrier and inactivating the conveyer system to stop the cleaner sheet thereat, a cleaning behavior, in which the latent image carrier is activated whilst the cleaner sheet is maintained nipped between nipping rollers in the conveyer system, a forwarding behavior to forward the cleaner sheet for a predetermined forwarding length, and repeating the cleaning behavior.

### CROSS REFERENCE TO RELATED APPLICATION

This application claims priority from Japanese Patent Application No. 2009-251286, filed on Oct. 30, 2009, the entire subject matter of which is incorporated herein by reference.

### BACKGROUND

1. Technical Field

An aspect of the present invention relates to an image forming apparatus, more specifically, to an image forming apparatus with a latent image carrier to be cleaned by a cleaner sheet and a method therefor.

2. Related Art

Methods to cleaning a latent image carrier of an image forming apparatus have been suggested. For example, register rollers and fixing rollers to convey a cleaner sheet may be manipulated to rotate in different peripheral velocity from a peripheral velocity of a photosensitive drum (i.e., the latent image carrier) so that the cleaner sheet is chafed with the photosensitive drum to scrape the surface of the photosensitive drum. For another example, the cleaner sheet may be provided with a stopper means to be attached to an edge of a sheet inlet so that a feeding speed of the cleaner sheet is reduced and the cleaner sheet remains in a position.

### SUMMARY

In the former way, the cleaner sheet cleans the photosensitive drum whilst being carried by the photosensitive drum. In other words, the cleaner sheet is not maintained in a position steadily. Therefore, when the cleaner sheet is not firmly chafed with the photosensitive drum, desirable quality of cleaning may not be achieved. In the latter way, the cleaner sheet may be maintained in a position, but solely a part of the cleaner sheet is chafed with the rolling photosensitive drum. Therefore, again, desirable quality of cleaning may not be achieved.

In view of these deficiencies, the present invention is advantageous in that an image forming apparatus, in which the cleaner sheet can efficiently clean the latent image carrier, is provided.

According to an aspect of the present invention, an image forming apparatus is provided. The image forming apparatus includes a latent image carrier to carry a latent image and a developer agent adhered thereto, a conveyer system including nipping rollers to convey a sheet to vicinity of the latent image carrier, the nipping rollers nipping the sheet therebetween and being rotatable to convey the nipped sheet, a switching system to switch operation modes of the image forming apparatus between an image forming mode, in which the developer agent is transferred onto the sheet conveyed to the vicinity of the latent image carrier, and a cleaning mode, in which an object adhered on the latent image carrier is removed therefrom by a cleaner sheet, and a cleaning controller to control a cleaning operation in the cleaning mode. The cleaning operation includes activating the conveyer system to convey the cleaner sheet at least until a front end of the cleaner sheet reaches a position opposite from the latent image carrier and inactivating the conveyer system to stop the cleaner sheet thereat to maintain the cleaner sheet nipped between the nipping rollers, a cleaning behavior, in which the latent image carrier is activated whilst the cleaner sheet is maintained nipped between the nipping rollers, a forwarding behavior to forward the cleaner sheet for a predetermined forwarding length by activation of the conveyer system and the latent image carrier, and repeating the cleaning behavior until a count of the cleaning behavior reaches a predetermined number.

According to another aspect of the present invention, a method to clean a latent image carrier in an image forming apparatus in cooperation with a cleaner sheet is provided. The latent image carrier carries a latent image and a developer agent adhered thereto. The method includes conveying the cleaner sheet by activation of a conveyer system including nipping rollers at least until a front end of the cleaner sheet reaches a position opposite from the latent image carrier and inactivating the conveyer system to stop the cleaner sheet thereat to maintain the cleaner sheet nipped between the nipping rollers, a cleaning behavior, in which the latent image carrier is activated whilst the cleaner sheet is maintained nipped between the nipping rollers, a forwarding behavior to forward the cleaner sheet for a predetermined forwarding length by activation of the conveyer system and the latent image carrier, and repeating the cleaning behavior until a count of the cleaning behavior reaches a predetermined number.

### BRIEF DESCRIPTION OF THE ACCOMPANYING DRAWINGS

FIG. 1 is a cross-sectional side view of an image forming apparatus according to an embodiment of the present invention.

FIG. 2 is a block diagram to illustrate electric configuration of the image forming apparatus according to the embodiment of the present invention.

FIG. 3 illustrates positional relation in a sheet-conveyer system to convey a cleaner sheet in the image forming apparatus according to the embodiment of the present invention.

FIG. 4 illustrates positional relation between an interval length between photosensitive drums and a forwarding length of the cleaner sheet in the image forming apparatus according to the embodiment of the present invention.

FIG. 5 is a flowchart to illustrate a cleaning operation in the image forming apparatus according to the embodiment of the present invention.

FIG. 6 illustrates behaviors of the cleaner sheet in the cleaning operation in the image forming apparatus according to the embodiment of the present invention.

### DETAILED DESCRIPTION

Hereinafter, an embodiment according to the present invention will be described with reference to the accompanying drawings.

### 1. Overall Configuration of Printer 1

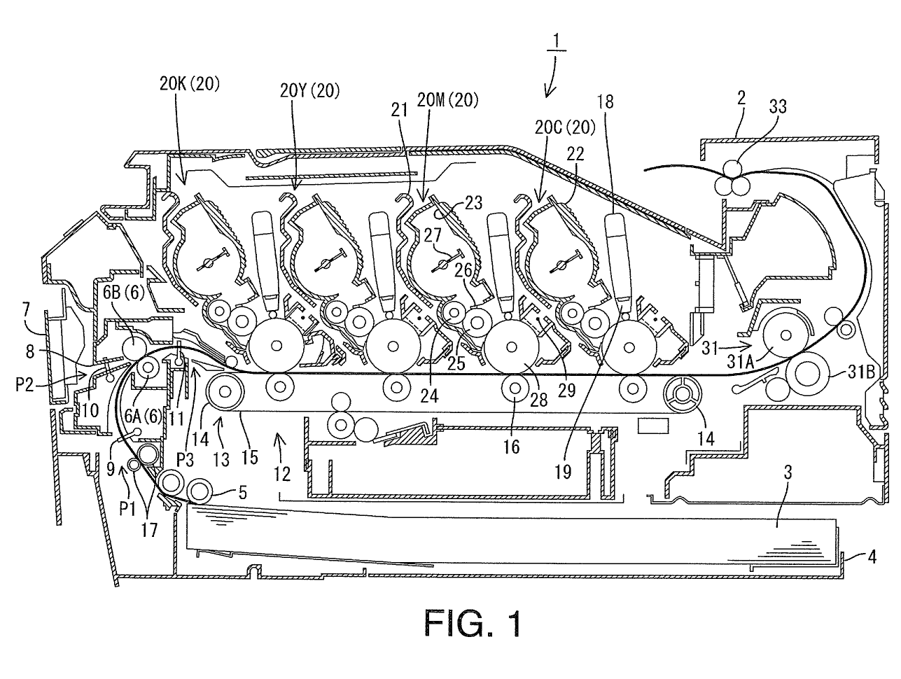

An overall configuration of a printer 1 will be described with reference to FIG. 1. The printer 1 is a direct transfer tandem-typed color LED printer, which forms an image in four different colors of toners. In the present embodiment, the four colors are black (K), yellow (Y), magenta (M), and cyan (C). In the following description, a left-hand side of the printer 1 as shown in FIG. 1 will be referred to as front of the printer 1, and a right-hand side of the printer 1 as shown in FIG. 1 will be referred to as rear of the printer 1. The printer 1 includes a plurality of similarly-configured components. Description of such components will be represented by one of those, and description of remaining of the components will be omitted. The printer 1 may not necessarily be a direct tandem-typed color LED printer, but may be, for example, a color laser printer, a monochrome laser, a copier, or a multifunction peripheral device having a copying function.

The printer 1 has a casing 2 and a sheet-feed tray 4, in which sheets 3 of recording paper are stored in a lower section of the casing 2. In an upper front position with respect to the sheet-feed tray 2, a sheet-feed roller 5 to pick up and feed the sheet 3 one-by-one in a feeding path P1 is arranged.

Along the feeding path P1, auxiliary sheet-feed rollers 17 and register rollers 6 are arranged. The register rollers include a driving roller 6A and a driven roller 6B. The driving roller 6A is connected to a sheet-feed motor 47 via a train of gears (not shown) so that driving force generated in the sheet-feed motor 47 is transmitted to the driving roller 6A.

In a front section of the printer 1, a manual sheet-feed guide 7, which guides sheets of paper (not shown) set thereon in an insert path P2 through a manual-feed slot 8, is provided. The manual-feed slot 8 is formed to extend inward to direct the sheet in vicinity to the register rollers 6. Further inward from the register rollers 6, a feeding path P3, which directs the sheet to a belt unit 13 of an image forming unit 12, is formed.

The register rollers 6 convey the sheet 3, which is fed from the sheet-feed tray 4 through the feeding path P1 and from the manual sheet-feed guide 7 through the insert path P2, to a top of the belt unit 13 through the feeding path P3. On the feeding path P1, the insert path P2, and the feeding path P3 are arranged a pre-registration sensor 9, a manual insertion sensor 10, and a post-registration sensor 11, respectively. The pre-registration sensor 9, the manual insertion sensor 10, and the post-registration sensor 11 detect presence of the sheet 3 in the respective positions.

The image forming unit 12 includes the belt unit 13, exposure units 18, a processing unit 20, and a fixing unit 31.

The belt unit 13 is arranged in a position opposite from photosensitive drums 28K, 28Y, 28M, 28C, which will be described later, and forwards the sheet 3 conveyed by the register rollers 6. The belt unit 13 has a pair of belt-supporting rollers 14, one of which is arranged in a position closer to the front, and the other of which is arranged in a position closer to the rear of the printer 1, and an endless belt 15, which is extended to roll around the belt-supporting rollers 14. When one of the belt-supporting rollers 14 closer to the rear is driven to rotate in a predetermined direction (i.e., a clockwise in FIG. 1), the belt 15 rolls in the direction of rotation of the belt-supporting rollers 14 accordingly, and the sheet 3 placed on a top surface of the belt 15 is carried toward the rear of the printer 1. Four transfer rollers 16, including transfer rollers 16K, 16Y, 16M, 16C for the four colors, are arranged to rotate in positions between the two belt-supporting rollers 14 and underneath the top portion of the belt 15.

The four exposure units 18, each of which is provided for one of the K, Y, M, C colors, are arranged in positions above the belt unit 13. Each of the exposure units 18 includes an LED unit (not shown) corresponding to one of the four colors and an LED head 19 in a lower-end section thereof. The exposure unit 18 is controlled to emit a beam corresponding to image data toward a surface of a photosensitive drum 28.

The processing unit 20 includes four processing cartridges 20K, 20Y, 20M, 20C, which are for the K, Y, M, C colors respectively. Each of the processing cartridges 20K, 20Y, 20M, 20C includes a cartridge frame 21 and a developer cartridge 22 to be detachably attached to the cartridge frame 21. The developer cartridge 22 includes a toner reservoir 23, in which toner being a developer agent for one of the K, Y, M, C colors is stored. The developer cartridge 22 further includes a toner-supplier roller 24, a developer roller 25, and a flattening blade 26 in lower positions than the toner reservoir 23.

The toner in the toner reservoir 23 is supplied to the developer roller 25 according to rotation of the tonner-supplier roller 24 and charged positively by friction created between the tonner-supplier roller 24 and the developer roller 25. The positively charged toner is carried by rotation of the developer roller 25 to become in contact with the flattening blade 26, which smoothes the toner evenly on the surface of the developer roller 25. Thus, the toner is applied evenly on the surface of the developer roller 25 in a thin layer.

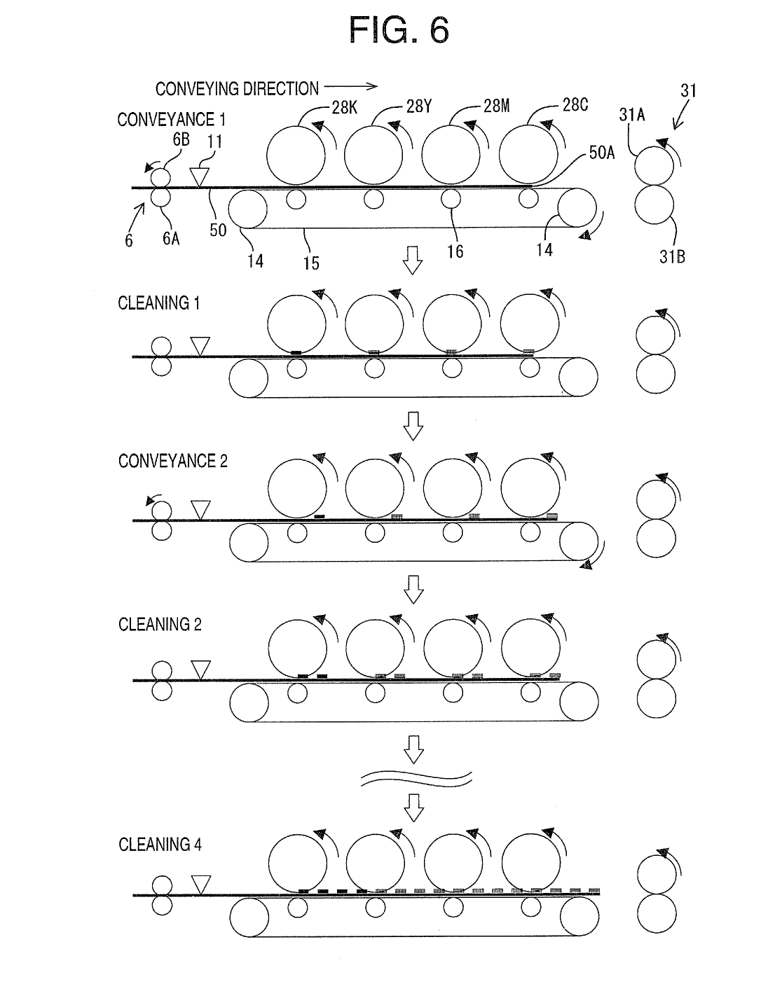

The processing unit 20 includes four photosensitive drums 28, including photosensitive drums 28K, 28Y, 28M, 28C, and four chargers 29, each of which corresponds for one of the K, Y, M, C colors. The photosensitive drums 28 and the chargers 29 are arranged in positions lower than the cartridge frames 21. The photosensitive drums 28K, 28Y, 28M, 28C are arranged in line along the sheet-feeding path P3 in the order given with respect to a direction of sheet-feeding (see FIG. 6). In the present embodiment, the photosensitive drum 28K in a most upstream position may be referred to as a first photosensitive drum, the photosensitive drum 28Y in a next upstream position may be referred to as a second photosensitive drum, the photosensitive drum 28M in a third upstream position may be referred to as a third photosensitive drum, and the photosensitive drum 28C in a fourth upstream position may be referred to as a fourth photosensitive drum.

Each of the photosensitive drums 28K, 28Y, 28M, 28C is coated with a positively chargeable photosensitive layer and pressed against one of the corresponding transfer rollers 16 to nip the belt 15. When an image is formed, the surface of the photosensitive drum 28 is uniformly charged positively by the charger 29. The positively charged surface is selectively exposed to the beam from the exposure unit 18 according to the image to be formed, and a latent image corresponding to the image is formed on the surface of the photosensitive drum 28.

The positively charged toner, which is carried by the developer roller 25, is provided to the latent image formed on the surface of the photosensitive drum 28. Thus, the latent image is developed to appear on the surface of the photosensitive drum 28 as a toner image. The toner image is transferred to the sheet 3 when the sheet 3 being carried on the belt 15 comes to the nipped section between the photosensitive drum 28 and the transfer roller 16 due to negative transfer bias applied to the transfer roller 16. The above image transferring behaviors of the processing unit 20 are conducted for four times to form the image in K, Y, M, C colors.

The sheet 3 with the transferred image is further carried by the belt unit 13 to the fixing unit 31. The fixing unit 31 includes a heat roller 31A with a heater (not shown) and a pressure roller 31B to press the sheet 3 against the heat roller 31A. When the sheet 3 is conveyed through the fixing unit 31, the sheet 3 with the image is pressed onto the heat roller 31A so that the transferred toner image is thermally fixed onto the surface of the sheet 3. The sheet 3 with the fixed image is directed upward to be ejected by ejector rollers 33 out of the casing 2.

The printer 1 according to the present embodiment can operate in an image forming mode, in which the toner image on the photosensitive drum 28 is transferred to the sheet 3, and a cleaning mode, in which object adhered on the surfaces of the photosensitive drums 28 is removed. The operation modes can be switched according to a user's instruction entered, for example, through the operation unit 46. In one embodiment, the printer 1 can be configured to initially enter the printing mode when the printer 1 is powered on, and the operation modes can be switched from the printing mode to the cleaning mode when the instruction to shift in the cleaning mode is entered. The printer 1 can be configured to return in the printing mode automatically after completion of a cleaning operation in the cleaning mode.

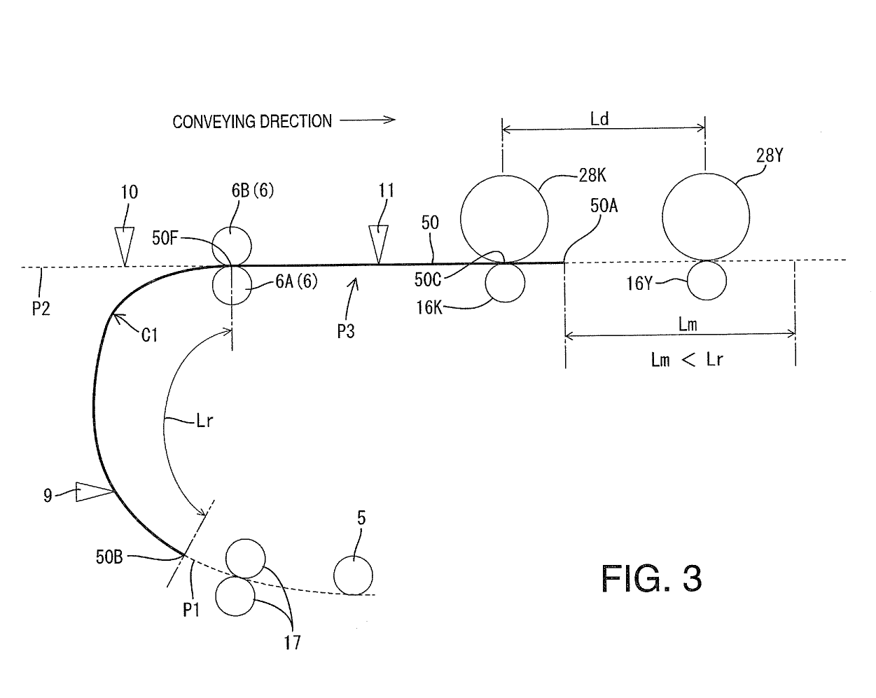

When the printer 1 is instructed to shift in the cleaning mode, the printer 1 needs to be provided with a cleaner sheet 50 through the sheet-feed tray 4 or the manual-feed slot 8. For example, the cleaner sheet 50 may be set in the sheet-feed tray 4. When the cleaner sheet 50 is provided via the sheet-feed tray 4, the cleaner sheet 50 is carried by sheet-conveying parts including the sheet-feed roller 5 and the auxiliary sheet-feed rollers 17 to the vicinity of the photosensitive drums 28 (see FIG. 3), in which the object adhered to the photosensitive drums 28 is removed by the cleaner sheet 50. The cleaner sheet 50 in the present embodiment has a cohesive characteristic, which enables the object adhered to the photosensitive drums 28 to be removed therefrom when the photosensitive drums are chafed with the cleaning sheet 50.

### 2. Electric Configuration of the Printer

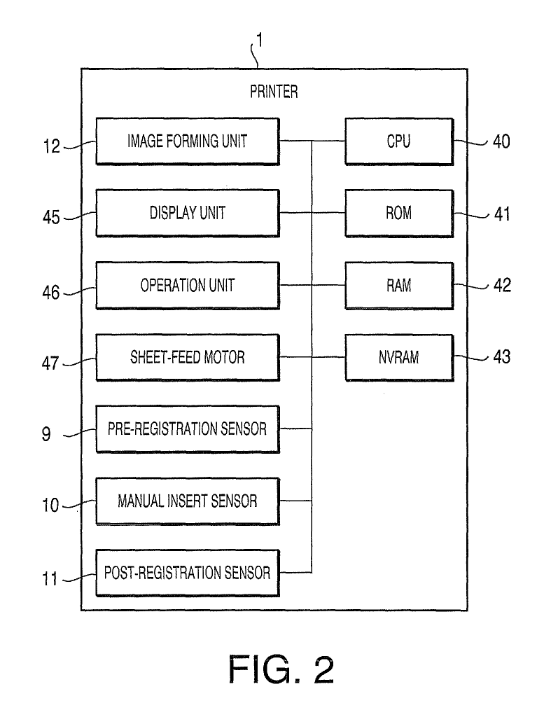

Electric configuration of the printer 1 according to the embodiment of the present invention will be described with reference to FIG. 2.

The printer 1 is provided with a CPU 40, a ROM 41, a RAM 42, and a non-volatile RAM (NVRAM), which are interconnected with the image forming unit 12, the pre-registration sensor 9, the manual insertion sensor 10, the post-registration sensor 11, a display unit 45, an operation unit 46, and a sheet-feed motor 47.

The display unit 45 includes a liquid crystal display (not shown) to display a screen for inputting operational settings of the printer 1 and lamps (not shown) to indicate operational status of the printer 1. The operation unit 46 includes a plurality of buttons (not shown), which are operated by a user to enter instructions for manipulating the printer 1.

The ROM 41 is a data storage, in which programs to manipulate the printer 1 are stored. The CPU 40 runs the programs to manipulate the printer 1 and stores data generated in the operations in the RAM 42 and the NVRAM 43.

The CPU 40 switches the printing mode and the cleaning mode according to an instruction from the user, which is, for example, entered through the operation unit 46. When selection of the printing mode is entered, the CPU 40 manipulates the image forming unit 12 to have toner images on the photosensitive drums 28 transferred onto the sheet 3 and forms an image on the sheet 3.

When selection of the cleaning mode is entered, the CPU 40 conducts a cleaning operation to clean the photosensitive drums 28. The cleaning operation includes a series of repetitive cleaning behaviors. In a first cleaning behavior, the CPU 40 manipulates the sheet-conveying parts such as the belt unit 13 and the register rollers 6 to convey the cleaner sheet 50. When the cleaner sheet 50 is carried by the sheet-conveying parts, and the cleaner sheet 50 comes to a position opposite from the photosensitive drums 28K, 28Y, 28M, 28C, the sheet-conveying movement of the sheet-conveying parts is ceased. In particular, when a front end 50A of the cleaner sheet 50 reaches a position opposite from the fourth photosensitive drum 28C or further, the CPU 40 inactivates the sheet-conveying parts to stop the sheet-conveying movement. In terms of the cleaner sheet 50 and the sheet 3, an edge which comes in front with respect to a direction to be carried in the feeding paths P1, P2, P3 is referred to as a “front end” regardless of the orientation of the printer 1. When the front end 50A reaches the position opposite from the fourth photosensitive drum 28C, the CPU 40 drives the photosensitive drums 28K, 28Y, 28M, 28C to rotate whilst the cleaner sheet 50 is maintained nipped between the register rollers 6. Accordingly, the peripheral surfaces of the photosensitive drums 28K, 28Y, 28M, 28C are wiped by portions of the cleaner sheet 50, which are nipped between the photosensitive drums 28K, 28Y, 28M, 28C and the transfer rollers 16.

In the above behavior, a position of the front end 50A of the cleaner sheet 50 can be determined, for example, based on a length of elapsed time starting from detection of the front end 50A by the post-registration sensor 11. That is, whilst a conveying speed of the cleaner sheet 50 and a length between the post-registration sensor 11 and the nipping point of the fourth photosensitive drum 28C are known, the CPU 40 can determine the position of the front end 50A based on the length of elapsed time after detection of the front end 50A at the post-registration sensor 11.

After the first cleaning behavior, the CPU 40 manipulates the sheet-conveying parts and the photosensitive drums 28K, 28Y, 28M, 28C to resume conveying the cleaner sheet 50 further for a predetermined forwarding length Lm, which is shorter than a remaining length Lr. The remaining length Lr is a length between a nipped portion 50F (see FIG. 3) of the cleaner sheet 50 and a rear end 50B of the cleaner sheet 50. The nipped portion 50F is a point in which the cleaner sheet 50 is nipped between the register rollers 6. When the cleaner sheet 50 is conveyed for the predetermined forwarding length Lm, the CPU 40 stops the sheet-conveying movement, and the cleaning behavior is repeated for a second time. In the present embodiment, the predetermined forwarding length Lm is limited to be shorter than the remaining length Lr so that the cleaner sheet 50 is maintained held by the register rollers 6. If the cleaner sheet 50 is carried for a longer length than the remaining length Lr, the cleaner sheet 50 is released from the register rollers, and the cleaning behavior cannot be repeatedly conducted.

When the cleaning behaviors are repeated in the cleaning operation, the portions of the cleaner sheet 50 to become in contact with the photosensitive drums 28 are shifted so that the surfaces of the photosensitive drums 28 can be effectively wiped by unused portions of the cleaner sheet 50.

In this regard, it is preferable that the predetermined forwarding length Lm avoids falling on an integral multiple length of an interval length Ld, which is an interval range between adjoining photosensitive drums 28.

Thus, when the front end 50A of the cleaner sheet 50 is carried to the position opposite from the fourth photosensitive drum 28C, which is arranged in the lowermost-stream position amongst the four photosensitive drums 28, the CPU 40 conducts the cleaning behavior for the photosensitive drums 28K, 28Y, 28M, 28C. Thereafter, the CPU 40 manipulates the sheet-conveying parts to carry the cleaner sheet 50 further for the forwarding length Lm and repeats the cleaning behavior thereat. In this regard, the portions of the cleaner sheet 50 which were used to wipe the photosensitive drums 28K, 28Y, 28M, 28C in the previous cleaning behavior are avoided to be used in the repeated cleaning behavior. Accordingly, the surfaces of the photosensitive drums 28K, 28Y, 28M, 28C are effectively cleaned by the unused portions of the cleaner sheet 50.

It is to be noted, in the present embodiment, the cleaner sheet 50 is held in position by the register rollers 6 during the cleaning behavior. However, the cleaner sheet 50 may be held by the auxiliary sheet-feed rollers 17 during the cleaning behavior.

### 3. Cleaning Operation

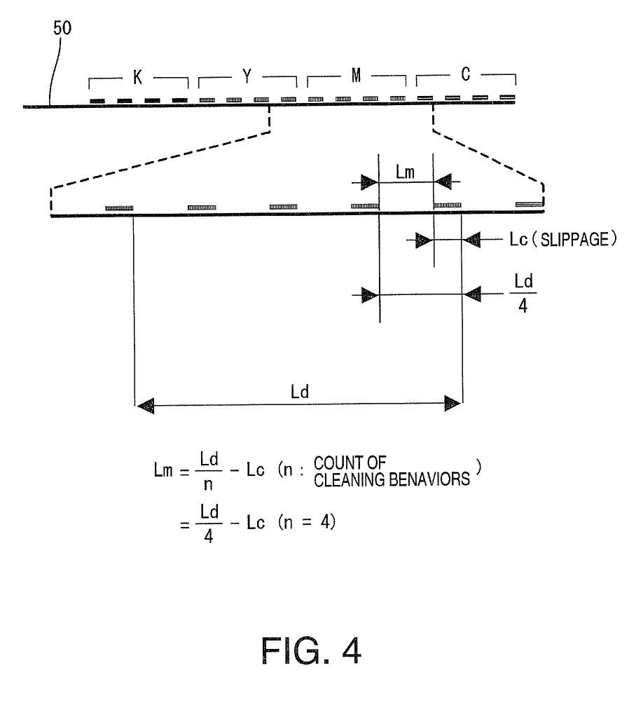

The cleaning operation will be described in detail with reference to FIGS. 4-6. In the cleaning operation according to the present embodiment, the cleaning behavior is conducted for four times. The forwarding length Lm is represented in a formula: Lm=(Ld/n)−Lc=(Ld/4)−Lc. In the formula, the variable “n” indicates a count of cleaning behaviors in the cleaning operation. The sign “Lc” indicates an assumable amount for the cleaner sheet 50 to slip in the feeding path P3 during the cleaning behavior whilst the cleaner sheet 50 is held by the register rollers 6. The slippage of the cleaner sheet 50 can be caused in the cleaning behavior according to the rotation of the photosensitive drums 28. Although the cleaner sheet 50 may be held by the register rollers 6 during the cleaning behavior, the cleaner sheet 50, which is affected by the rotating force of the photosensitive drums 28, may not be firmly caught thereat. However, due to the cohesive feature of the cleaner sheet 50, the cleaner sheet 50 is in cohesive contact with the belt 15, and the slippage amount Lc is maintained substantially small in order for the cleaning sheet 50 to stably clean the photosensitive drums 28.

The slippage amount Lc is so small that the photosensitive drums 28 are rotated on substantially same spots of the cleaner sheet 50 during the cleaning behavior. In other words, the slippage amount Lc is not large enough to constantly supply unused portions of the cleaner sheet 50 to the photosensitive drums 28. Consequently, even when a substantial length of time is allocated to the cleaning behavior, the photosensitive drums 28 may be cleaned by the same spots of the cleaner sheet 50 and may not be cleaned effectively. In the present embodiment, therefore, the cleaner sheet 50 is forwarded for the length Lm after a cleaning behavior in order to supply unused portions of the cleaner sheet 50 to the photosensitive drums 28, and the cleaning behavior is repeated in cooperation with the unused portions of the cleaner sheet 50. In this way, the photosensitive drums 28 can be cleaned by the unused portions of the cleaner sheet 50 effectively each time the cleaning behavior is repeated within one cleaning operation.

As has been mentioned above, the forwarding length Lm in the present embodiment requires to be shorter than the remaining length Lr of the cleaner sheet 50. Further, the forwarding length Lm is shorter than the interval length Ld, which is the length between two nipped points in which the cleaner sheet 50 contacts the two adjoining photosensitive drums 28. Additionally, the forwarding length Lm should avoid an integral multiple of the interval length Ld. Furthermore, due to the condition (Ld/4)−Lc<Ld−Lc, the forwarding length Lm becomes inevitably smaller than a length remaining after subtraction of the slippage Lc from the interval length Ld. Therefore, the length of the cleaner sheet 50 to be carried for the repeated cleaning behaviors can be smaller so that the cleaner sheet 50 can clean the photosensitive drums 28 in a shorter length. Further, an entire length of the cleaner sheet 50 can be shortened.

It is to be noted, in the present embodiment, that the interval lengths Ld between the two adjoining photosensitive drums 28 are all equivalent, and the photosensitive drums 28 are driven in synchronization with one another.

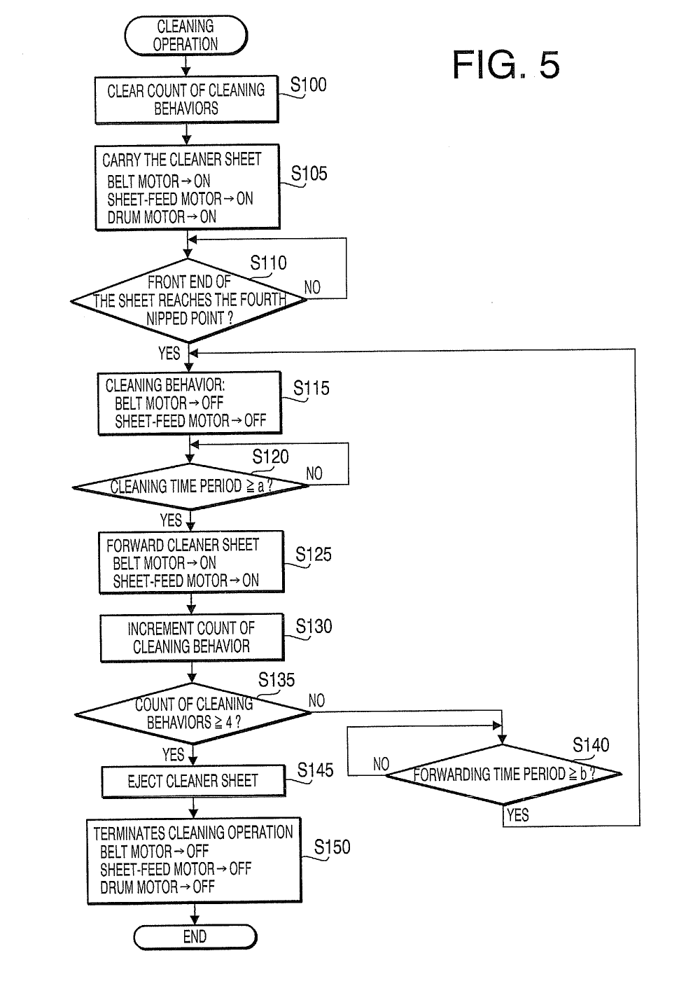

A flow of the cleaning operation will be described with reference to FIG. 5. The cleaning operation is activated according to a predetermined program upon, for example, entry of the selection of the cleaning mode through the operation unit 46. When the cleaning operation starts, in S100, the CPU 40 clears a count of cleaning behaviors stored in a predetermined storage area in, for example, the RAM 42. Thereafter, in S105, the CPU 40 activates a belt motor (not shown), the sheet-feed motor 47, and a drum motor (not shown) to drive the photosensitive drums 28 to drive the sheet-conveying parts and carry the cleaner sheet 50 to a cleaning start position. Accordingly, the sheet-feed roller 5, the register rollers 6, the belt-supporting rollers 14, the photosensitive drums 28, and the heat roller 31A are rotated to pick up and carry the cleaner sheet 50 from the sheet-feed tray in the sheet-feeding paths P1, P3.

In S105 and in following steps described below, the heat roller 31A may not necessarily be driven when the cleaner sheet 50 is carried. However, it is preferable that the fixing unit 31 is rotated whilst the cleaner sheet 50 is carried in order to avoid sheet jam in the fixing unit 31. In this regard, heat generation in the heat roller 31A may optionally be ceased.

In S110, the CPU 40 examines to judge as to whether the front end 50A of the cleaner sheet 50 reaches the nipped point of the fourth photosensitive drum 28C, in which the cleaner sheet 50 is nipped between the fourth photosensitive drum 28C and the corresponding transfer roller 16C. If the front end 50A has not reached the nipped point (S110: NO), the CPU 40 continues to convey the cleaner sheet 50. When the front end 50A reaches the nipped point of the fourth photosensitive drum 28C (S110: YES), the CPU 40 determines that a first conveyance (see FIG. 6) is completed. The flow proceeds to S115.

In S115, the CPU 40 starts a first cleaning behavior to clean the photosensitive drums 28. Namely, rotation of the drum motor and a motor driving the heat roller 31A is maintained whilst the belt motor and the sheet-feed motor 47 are inactivated (see FIG. 6). Thus, the photosensitive drums 28 are rotated whilst the cleaner sheet 50 is held by the register rollers 6. Accordingly, the surfaces of the photosensitive drums 28 are cleaned by the cleaner sheet 50, which is slipping to be shifted for the slippage Lc.

In S120, the CPU 40 examines as to whether predetermined time period (“a” seconds) for the first cleaning behavior has elapsed. The “a” seconds is a time period, for example, in which the photosensitive drums 28 can rotate for once (i.e., 360 degrees). If the predetermined time period has elapsed (S120: YES), in S125, the CPU 40 starts second conveyance and activates the belt motor and the sheet-feed motor 47 to carry the cleaner sheet 50 for the forwarding length Lm. Meanwhile, the rotation of the drum motor and the motor for the heat roller 31A are maintained. Thereafter, in S130, the CPU 40 increments the count of cleaning behaviors conducted in the cleaning operation by 1. In S135, the CPU 40 judges as to whether the count of cleaning behaviors is 4 or more.

If the count of cleaning behaviors is smaller than 4 (S135: NO), in S140, the CPU 40 judges as to whether a time period for forwarding the cleaner sheet 50 since S125 has reached a predetermined time period (“b” seconds). The “b” seconds is a time period, which is required to convey the cleaner sheet 50 for the forwarding length Lm. In the present embodiment, the forwarding length Lm is determined by multiplying the known conveying speed of the cleaner sheet 50 by the elapsed time period since S125.

In S140, if the time period “b” seconds has elapsed (S140: YES), that is, when the cleaner sheet 50 was carried for the forwarding length Lm, the flow returns to S115, and the CPU 40 conducts a second cleaning behavior (see FIG. 6). The steps 115-S140 are repeated until a fourth cleaning behavior (see FIG. 6) is completed.

When the fourth cleaning behavior is completed (S135: YES), the flow proceeds to S145. In S145, the CPU 40 maintains the motors rotating to eject the cleaner sheet 50. The ejected cleaner sheet 50 is guided to a top surface of the casing 2.

In S145, the cleaner sheet 50 may not necessarily be ejected. Instead, the cleaner sheet 50 may be maintained nipped between the photosensitive drums 28 and the transfer rollers 16, and held by the register rollers 6 so that the cleaning operation including the four cleaning behaviors can be repeated for a plurality of times. In this regard, the cleaner sheet 50 may be forwarded for at least triple length of the forwarding length Ld (i.e., 3 Ld) before a new cleaning operation starts so that an unused portion of the cleaner sheet 50 is used in the new cleaning operation. Thus, the photosensitive drums 28 can be more reliably cleaned in the increased number of cleaning behaviors. In order to repeat the cleaning operations for a plurality of times and avoid wiping the photosensitive drums 28 in the used portions of the cleaner sheet 50, the cleaner sheet 50 should have a substantial length which is at least 6 Ld in addition to a length between the nipped portion (50F in FIG. 3) of the register rollers 6 and the nipped portion (50C in FIG. 3) of the first photosensitive drum 28K and the transfer roller 16.

When conveyance of the cleaner sheet 50 is completed and the cleaner sheet 50 is ejected, in S150, the CPU 40 terminates the cleaning operation and inactivates the belt motor, the sheet-feed motor 74, and the drum motors. After termination of the cleaning operation, CPU 40 can switch the operation modes from the cleaning mode to the printing mode.

According to the above flow, the CPU 40 repeats the conveyance and the cleaning behavior for a plurality of times until the cleaner sheet 50 is carried from the cleaning start position to the interval length Ld being the length between the two nipped points in which the cleaner sheet 50 contacts the two adjoining photosensitive drums 28.

In the above flow, the count “n” of the cleaning behaviors to be conducted within the interval length Ld can be modified arbitrarily. In the above flow, further, when the cleaning operation including the four cleaning behaviors is repeated for a plurality of times, a portion of the cleaner sheet 50 having the length of the interval Ld of the photosensitive drums 28 can be used in a single cleaning behavior. In this regard, the forwarding length is greater than the interval length Ld and smaller than the remaining length Lr of the cleaner sheet 50 (Ld<Lm<Lr); therefore, the length of the portion to be used in the single cleaning behavior can be longer, and a longer time period for the single cleaning behavior can be set. Further, the number of cleaning behaviors in the cleaning operation is reduced to be smaller compared to the number of cleaning behaviors in a cleaning operation in which the cleaning behavior is repeated for four times within the interval length Ld. Therefore, at least some of the steps to forward the cleaner sheet 50 and judge as to whether the cleaner sheet 50 is carried for the predetermined length can be effectively omitted. In the above embodiment, furthermore, the cleaner sheet 50 may not necessarily be supplied in the feeding path P3 from the sheet-feed tray 4, but may be supplied through the manual-feed slot 8.

### 4. Effects

According to the printer described above, the cleaning behavior to clean the photosensitive drums 28K, 28Y, 28M, 28C by the cleaner sheet 50 held between the register rollers 6 is repeated for a plurality of times. In particular, each cleaning behavior is performed with an unused portion of the cleaner sheet 50. Therefore, the cleaner sheet 50 can be efficiently used to clean the photosensitive drums 28 effectively.

Specifically, the plurality of cleaning behaviors are conducted dividedly within the interval length Ld of the cleaner sheet 50; therefore, it is not necessary to forward the cleaner sheet 50 for a long distance in order to have an unused portion used in a succeeding cleaning behavior after one cleaning behavior, and a length in which the cleaner sheet 50 is forwarded for a succeeding cleaning behavior can be shorter.

Further, the cleaning behavior starts when the front end 50A of the cleaner sheet 50 reaches the position opposite from the fourth photosensitive drum 28C, i.e., the nipped point between the fourth photosensitive drum 28C and the transfer roller 16C; therefore, the photosensitive drums 28 are prevented from being in direct contact with the belt 15 whilst the photosensitive drums 28 rotate.

Although an example of carrying out the invention has been described, those skilled in the art will appreciate that there are numerous variations and permutations of the image forming apparatus that falls within the spirit and scope of the invention as set forth in the appended claims. It is to be understood that the subject matter defined in the appended claims is not necessarily limited to the specific features or act described above. Rather, the specific features and acts described above are disclosed as example forms of implementing the claims.

For example, in the above embodiment, the cleaning operation to clean the four photosensitive drums 28K, 28Y, 28M, 28C evenly in the printer 1 is described. However, a cleaning behavior aimed specifically to a photosensitive drum (i.e., the first photosensitive drum 28K) in a most-upstream position with respect to the conveying direction can be performed. That is, when the cleaner sheet 50 is conveyed and the front end 50A of the cleaner sheet 50 reaches the nipped point of the first photosensitive drum 28K with the transfer roller 16K, the cleaning behavior is performed for the first photosensitive drum 28K. After the cleaning behavior, the cleaner sheet 50 can be carried for the forwarding length Lm, and a succeeding cleaning behavior can be performed again for the first photosensitive drum 28K thereat. It is to be noted, generally, that adhesive objects such as paper dust are most likely to adhere to the first photosensitive drum 28K, which is arranged in the most-upstream position, other than the photosensitive drums 28Y, 28M, 28C arranged in the lower-stream positions. Therefore, when the cleaning behavior aimed specifically to the first photosensitive drum 28K other than the photosensitive drums 28Y, 28M, 28C in the lower-stream positions is performed, the adhesive objects can be effectively removed. Further, when the cleaning behaviors for the other photosensitive drums 28Y, 28M, 28C in the lower-stream positions are omitted, a time period required for the cleaning operation can be shortened, and the photosensitive drum can be cleaned by a shorter length of the cleaner sheet 50.

In the above configuration, it is more preferable that the photosensitive drum 28K in the most-upstream position and the remaining photosensitive drums 28Y, 28M, 28C in the lower-stream positions can be driven separately. When the photosensitive drum 28K in the most-upstream position and the remaining photosensitive drums 28Y, 28M, 28C in the lower-stream positions can be driven separately, the remaining photosensitive drums 28Y, 28M, 28C can be controlled to stop whilst the photosensitive drum 28K in the most-upstream position is cleaned in the cleaning behavior. Accordingly, abrasion of the photosensitive drums 28Y, 28M, 28C and the belt 15 due to the direct contact with each other can be avoided. Namely, even when the front end 50A of the cleaner sheet 50 does not reach the position opposite from the fourth photosensitive drum 28C in the lowermost-stream position, and when the photosensitive drums 28Y, 28M, 28C in the lower-stream positions are in direct contact with the belt 15, the photosensitive drums 28Y, 28M, 28C and the belt 15 can be restricted from being rotated or rolled, and abrasion of the photosensitive drums 28Y, 28M, 28C with the belt 15, and vice versa, can be avoided.

For another example, the printer 1 may be configured to be operable in a monochrome-drum cleaning mode, in which the first photosensitive drum 28K to be used in monochrome printing is cleaned. When the printer 1 is in the monochrome-drum cleaning mode, the cleaner sheet 50 is carried at least to the position opposite from the monochrome photosensitive drum 28K, and the cleaning behavior can be started thereat. The CPU 40 can select to clean the photosensitive drum 28K in the monochrome-drum cleaning mode when, for example, the printer 1 has not been used for multi-color printing frequently but the printer 1 has been used mainly for monochrome printing in a predetermined past period.

With the monochrome-drum cleaning mode, in which cleaning of the photosensitive drums 28Y, 28M, 28C for colored developer agents is omitted, the cleaning behavior can be started once the front end 50A of the cleaner sheet 50 reaches the position opposite from the photosensitive drum 28K for monochrome printing. Therefore, the cleaning behavior can be activated in shorter time after the operation mode of the printer 1 is switched to the cleaning mode. Even with this configuration, when the printer 1 has been used for multi-color printing frequently, the printer can select to operate in the regular cleaning mode, in which all the photosensitive drums 28K, 8Y, 28M, 28C are cleaned.

Further, for another example, the interval lengths Ld between the two adjoining photosensitive drums 28 may not necessarily be a same length, but the cleaning method described above can be also applied to a printer having photosensitive drums aligned in line with different interval lengths therebetween. In this regard, it is preferable that the forwarding length Lm is calculated based on a longest interval length Ld amongst all the different interval lengths Ld in order to avoid overlapped use of once-used portions of the cleaner sheet 50 in repeated cleaning behaviors.

For another example, the photosensitive drums 28 may not necessarily be driven in synchronization with one another. The cleaning method described above can be also applied to a printer having separately-drivable photosensitive drums.

Furthermore, the number of photosensitive drums may not necessarily be four. For example, the cleaning method described above can be also applied to a printer having five or more photosensitive drums and to a printer having a single photosensitive drum.

What is claimed is:

1. An image forming apparatus, comprising:
a latent image carrier to carry a latent image and a developer agent adhered thereto;
a conveyer system including nipping rollers to convey a sheet to vicinity of the latent image carrier, the nipping rollers nipping the sheet therebetween and being rotatable to convey the nipped sheet;
a switching system to switch operation modes of the image forming apparatus between an image forming mode, in which the developer agent is transferred onto the sheet conveyed to the vicinity of the latent image carrier, and a cleaning mode, in which an object adhered on the latent image carrier is removed therefrom by a cleaner sheet; and
a cleaning controller to control a cleaning operation in the cleaning mode,
wherein the cleaning operation includes:
activating the conveyer system to convey the cleaner sheet at least until a front end of the cleaner sheet reaches a position opposite from the latent image carrier and inactivating the conveyer system to stop the cleaner sheet thereat to maintain the cleaner sheet nipped between the nipping rollers;
a cleaning behavior, in which the latent image carrier is activated whilst the cleaner sheet is maintained nipped between the nipping rollers;
a forwarding behavior to forward the cleaner sheet for a predetermined forwarding length by activation of the conveyer system and the latent image carrier; and
repeating the cleaning behavior until a count of the cleaning behavior reaches a predetermined number.

2. The image forming apparatus according to claim 1,
wherein the latent image carrier includes a plurality of latent image carriers aligned in line along a sheet-conveying direction, each of the latent image carriers carrying a developer agent in a different color;
wherein the conveyer system includes a forwarding unit arranged in a position opposite from the plurality of latent image carriers and to forward the conveyer sheet;
wherein the predetermined forwarding length excludes an integral multiple length of an interval length, which is between two contact points for the cleaner sheet to be in contact with two adjoining latent image carriers;
wherein the cleaner sheet is conveyed until the front end of the cleaner sheet reaches a position opposite from one of the latent image carriers arranged in a lowermost-stream position with respect to the sheet-feeding direction prior to the cleaning behavior to clean the latent image carriers;
wherein the plurality of latent image carriers are activated to be cleaned in the cleaning behavior; and
wherein the cleaner sheet is forwarded for the predetermined forwarding length by activation of the conveyer system and the plurality of latent image carriers in the forwarding behavior.

3. The image forming apparatus according to claim 2,
wherein the predetermined forwarding length is shorter than the interval length between the two contact points for the cleaner sheet to be in contact with two adjoining latent image carriers.

4. The image forming apparatus according to claim 3,
wherein the predetermined forwarding length is shorter than a length remaining after subtraction of a shifted length, in which the cleaner sheet is shifted during the cleaning behavior, from the interval length.

5. The image forming apparatus according to claim 3,
wherein the cleaning controller repeats the cleaning behavior and the forwarding behavior for a plurality of times until the cleaner sheet is shifted for the interval length.

6. The image forming apparatus according to claim 1,
wherein the latent image carrier includes a plurality of latent image carriers aligned in line along a sheet-conveying direction, each of the latent image carriers carrying a developer agent in a different color for multi-colored image forming;
wherein the conveyer system includes a forwarding unit arranged in a position opposite from the plurality of latent image carriers and to forward the conveyer sheet;
wherein the predetermined forwarding length excludes an integral multiple length of an interval length, which is between two contact points for the cleaner sheet to be in contact with two adjoining latent image carriers;
wherein the cleaner sheet is conveyed until the front end of the cleaner sheet reaches at least until a position opposite from one of the latent image carriers arranged in an uppermost-stream position with respect to the sheet-feeding direction prior to the cleaning behavior to clean the latent image carriers;
wherein at least the one of the latent image carriers arranged in the uppermost-stream position is activated to be cleaned in the cleaning behavior; and
wherein the cleaner sheet is forwarded for the predetermined forwarding length by activation of the conveyer system and at least the one of the latent image carriers arranged in the uppermost-stream position in the forwarding behavior.

7. The image forming apparatus according to claim 6,
wherein the predetermined forwarding length is shorter than the interval length between the two contact points for the cleaner sheet to be in contact with two adjoining latent image carriers.

8. The image forming apparatus according to claim 7,
wherein the predetermined forwarding length is shorter than a length remaining after subtraction of a shifted length, in which the cleaner sheet is shifted during the cleaning behavior, from the interval length.

9. The image forming apparatus according to claim 7,
wherein the cleaning controller repeats the cleaning behavior and the forwarding behavior for a plurality of times until the cleaner sheet is shifted for the interval length.

10. The image forming apparatus according to claim 6,
wherein the one of the latent image carriers arranged in the uppermost-stream position is a monochrome latent image carrier to carry a monochrome developer agent for monochrome-image forming;
wherein the cleaning mode includes a monochrome-carrier cleaning mode, in which the cleaning behavior is started when the front end of the cleaner sheet is conveyed at least to a position opposite from the monochrome latent image carrier; and
wherein the switching system switches to activate the monochrome-carrier cleaning mode when the cleaning mode is requested and when the image forming apparatus has been operated for monochrome-image forming more frequently.

11. A method to clean a latent image carrier in an image forming apparatus in cooperation with a cleaner sheet, the latent image carrier carrying a latent image and a developer agent adhered thereto, comprising:
conveying the cleaner sheet by activation of a conveyer system including nipping rollers at least until a front end of the cleaner sheet reaches a position opposite from the latent image carrier and inactivating the conveyer system to stop the cleaner sheet thereat to maintain the cleaner sheet nipped between the nipping rollers;
a cleaning behavior, in which the latent image carrier is activated whilst the cleaner sheet is maintained nipped between the nipping rollers;
a forwarding behavior to forward the cleaner sheet for a predetermined forwarding length by activation of the conveyer system and the latent image carrier; and
repeating the cleaning behavior until a count of the cleaning behavior reaches a predetermined number.
